(19) United States
(12) Patent Application Publication
(10) Pub. No.: US 2011/0181674 A1
(43) Pub. Date: Jul. 28, 2011

(54) Inkjet print head

(75) Inventors: Sung Koo Kang, Suwon (KR); Jae Hun Kim, Seoul (KR); Dong Hoon Kim, Seongnam (KR); Jae Woo Joung, Suwon (KR)

(73) Assignee: SAMSUNG ELECTRO-MECHANICS CO., LTD., Suwon (KR)

(21) Appl. No.: 12/923,903

(22) Filed: Oct. 13, 2010

(30) Foreign Application Priority Data
Jan. 25, 2010 (KR) 10-2010-0006351

(51) Int. Cl. B41J 2/17

(52) U.S. Cl. 347/94

(57) ABSTRACT

There is provided an inkjet print head including: a reservoir storing a first ink drawn in through an ink inlet; a pressure chamber storing the first ink drawn in from the reservoir and transferring the first ink to a nozzle by a driving force of an actuator; and a damper disposed between the pressure chamber and the nozzle and allowing the first ink to be mixed with a second ink drawn through an ink flow path for the second ink.

### CROSS-REFERENCE TO RELATED APPLICATIONS

This application claims the priority of Korean Patent Application No. 10-2010-0006351 filed on Jan. 25, 2010, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head allowing for the ejection of compound ink, i.e., ink which is formed of a combination of inks having different materials.

2. Description of the Related Art

In general, an inkjet print head converts electrical signals into physical impulses so that ink droplets are ejected through a small nozzle.

An inkjet print head may be manufactured without including a mask process. In this case, a reduction in the number of manufacturing processes and manufacturing costs as compared with a conventional inkjet print head manufacturing method may be achieved. In addition, the capital investment in manufacturing equipment is reduced and the physical space required for the installation of equipment is also advantageous over the conventional inkjet print head manufacturing method.

In recent years, the above-described advantages have allowed an inkjet print head to be applicable to a variety of fields including flat-panel displays such as liquid crystal displays (LCDs) and organic light emitting devices, flexible displays such as electronic paper, printed electronics components such as metal lines, organic thin film transistors (OTFTs), and the like.

In order to be applicable to those fields, various types of ink, without limitation to a single type of ink, may be used.

In the filed of a conventional inkjet print head, however, ink development is implemented by mixing a variety of materials. This may cause problems such as variations in the states of the mixed materials due to chemical reactions therebetween. For example, when gold nano-ink and cobalt complexes (cobalt herein serving to prevent cracks and assist in grain growth when gold is sintered) are mixed, grain stability is deteriorated and precipitation is caused. Therefore, there is a need for technologies in order to solve these problems.

### SUMMARY OF THE INVENTION

An aspect of the present invention provides an inkjet print head, in which compound ink, i.e., ink formed of a combination of inks having different materials is produced.

According to an aspect of the present invention, there is provided an inkjet print head including: a reservoir storing a first ink drawn in through an ink inlet; a pressure chamber storing the first ink drawn in from the reservoir and transferring the first ink to a nozzle by a driving force of an actuator; and a damper disposed between the pressure chamber and the nozzle and allowing the first ink to be mixed with a second ink drawn through an ink flow path for the second ink.

The ink flow path may include a further reservoir and a further pressure chamber symmetrically corresponding to the reservoir and the pressure chamber with the damper being disposed between the symmetrically opposed pressure chambers.

The ink flow path may be a circulation path disposed outwardly of the reservoir and the pressure chamber.

The ink flow path may be a path extending from a further ink inlet for the second ink to the damper.

The inkjet print head may further include a chamber plate having the pressure chamber provided therein, and a nozzle plate having the nozzle provided therein. The chamber plate may be stacked on the nozzle plate.

The inkjet print head may further include an intermediate plate interposed between the chamber plate and the nozzle plate and including the damper connecting the pressure chamber and the nozzle.

The inkjet print head may further include a further actuator for transferring the second ink of the ink flow path to the damper.

The damper may have a diameter gradually narrowed towards the nozzle.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partial plan view illustrating an inkjet print head according to an exemplary embodiment of the present invention;

FIG. 2 is a cross-sectional view illustrating the inkjet print head of FIG. 1;

FIG. 3 is an exploded cross-sectional view illustrating the inkjet print head of FIG. 1;

FIG. 4 is a cross-sectional view illustrating an inkjet print head according to another exemplary embodiment of the present invention;

FIG. 5 is an exploded cross-sectional view illustrating the inkjet print head of FIG. 4;

FIG. 6 is a cross-sectional view illustrating an inkjet print head according to another exemplary embodiment of the present invention;

FIG. 7 is a plan view illustrating the inkjet print head of FIG. 6;

FIG. 8 is a cross-sectional view illustrating an inkjet print head according to another exemplary embodiment of the present invention; and

FIG. 9 is a plan view illustrating the inkjet print head of FIG. 8.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In addition, the same reference numerals will be used throughout the drawings to refer to the same or like elements.

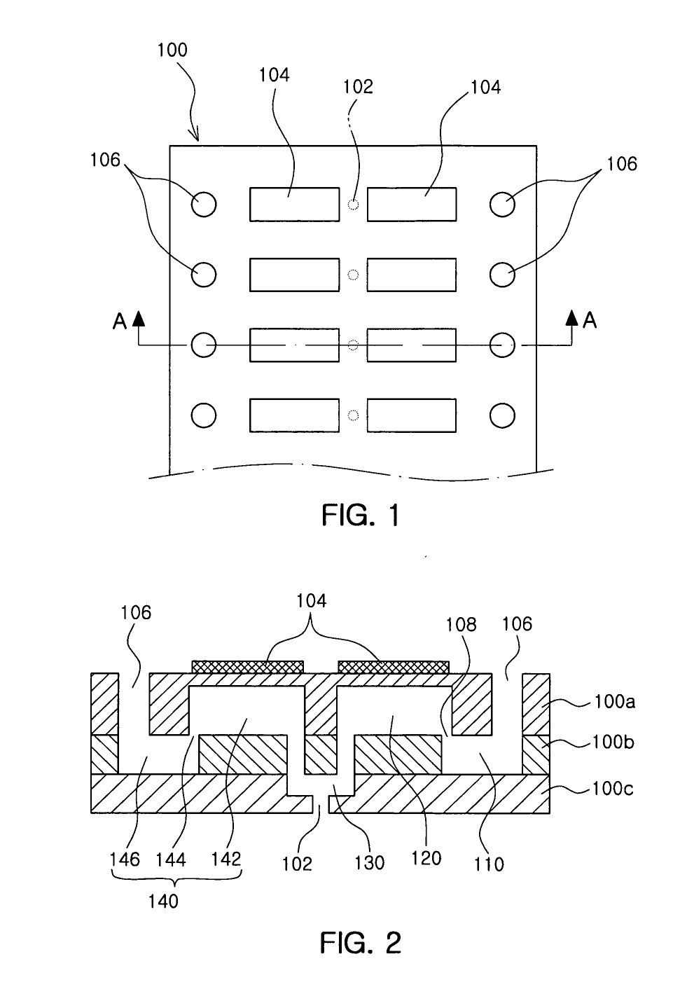

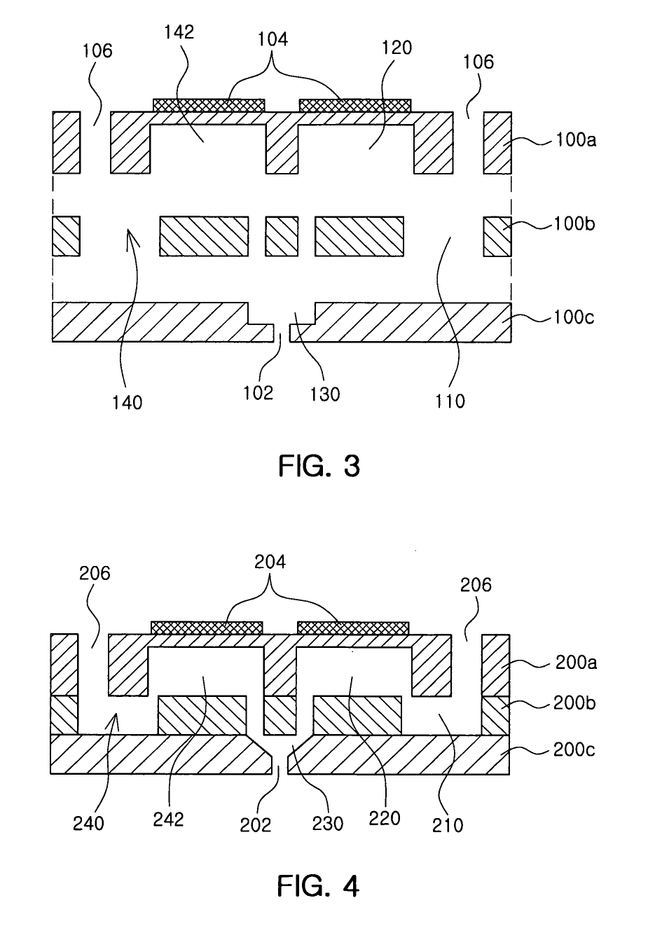

FIG. 1 is a partial plan view illustrating an inkjet print head according to an exemplary embodiment of the present invention. FIG. 2 is a cross-sectional view illustrating the inkjet print head of FIG. 1. FIG. 3 is an exploded cross-sectional view illustrating the inkjet print head of FIG. 1.

With reference to FIGS. 1 through 3, an inkjet print head may include a first reservoir 110, a first pressure chamber 120 and a damper 130.

The first reservoir 110 stores a first ink drawn in through a first ink inlet 106 and is formed inside a head portion 100.

Here, the first reservoir 110 forms a flow path connected to the first pressure chamber 120 through a first restrictor 108. The first ink is transferred to the first pressure chamber 120 through the first restrictor 108.

The first pressure chamber 120 is disposed inside the head portion 100 so as to be positioned directly below a first piezoelectric actuator 104. The first pressure chamber 120 is an ink storage chamber for transferring the first ink being drawn in to a nozzle 102 by a driving force of the first piezoelectric actuator 104. However, the invention is not limited to such a piezoelectric actuator.

The first pressure chamber 120 may be disposed to be higher than the first reservoir 110 inside the head portion 100. However, the invention is not limited thereto. The first pressure chamber 120 may be disposed at the same height as the first reservoir 110 according to a designer's intentions.

The damper 130 receives the first ink from the first pressure chamber 120. The first ink stored in the damper 130 is ejected to the outside through the nozzle 102.

In the damper 130, the first ink stored therein is mixed with a second ink drawn in through an ink flow path 140.

As shown in FIG. 2, the ink flow path 140 may have a mirrored structure with relation to the first pressure chamber 120, the first restrictor 108, and the first reservoir 110. Here, the second ink may represent types of ink different to the first ink.

Therefore, the ink flow path 140 may include a second pressure chamber 142 corresponding to the first pressure chamber 120, a second restrictor 144 corresponding to the first restrictor 108, and a second reservoir 146 corresponding to the first reservoir 110. Also, the second pressure chamber 142 is disposed so as to be positioned directly below a second piezoelectric actuator 105 corresponding to the first piezoelectric actuator 104.

However, the ink flow path 140 is not limited thereto, and it may have various forms according to a designer's intentions.

The ink flow path 140 is connected to the damper 130. As a result, two ink flow paths are connected to the single damper 130. Here, the number of ink flow paths may be two or more.

The damper 130 may have a diameter greater than that of the nozzle 102, but is not limited thereto. The damper 130 may have a multi-stage configuration by which the amount of inks ejected from the first and second pressure chambers 120 and 142 and the amount of inks ejected through the nozzle 102 can be controlled.

Conventionally, in order to develop new-types of ink, a variety of materials are required to be mixed. However, this may cause problems such as variations in the states of the mixed materials due to chemical reactions therebetween.

However, in the inkjet print head according to this embodiment, the second ink is drawn into the damper 130 through the ink flow path 140 and is subsequently mixed with the first ink, and the mixed first and second inks are ejected through the nozzle 102 immediately after being mixed in the damper 130. Since the mixed inks are ejected in a short period of time, the above-described problem may be solved. Accordingly, the inkjet print head allows for the ejection of compound ink, i.e., ink which is formed of a combination of inks having different materials.

The head portion 100 of the inkjet print head may be manufactured by stacking a chamber plate 100a, an intermediate plate 100b and a nozzle plate 100c so as to be bonded together.

The chamber plate 100a may include a plurality of first and second pressure chambers 120 and 142 disposed symmetrically, and the first ink inlet 106 and a second ink inlet 107 prepared for drawing inks therethrough.

The intermediate plate 100b may include the first and second reservoirs 110 and 146 having a large length extending in a longitudinal direction, and portions connecting the damper 130 and the first and second pressure chambers 120 and 142.

The nozzle plate 100c may be bonded to the bottom of the intermediate plate 100b. The nozzle plate 100c may have a plurality of nozzles 102 arranged in a row. However, the positions of the nozzles 102 are not limited thereto.

Also, the nozzle plate 100c may have the damper 130 formed therein. However, the position of the damper 130 is not limited thereto. The damper 130 may be formed in the intermediate plate 100b.

In this embodiment, a plurality of flow paths may be formed by an etching process, and thus the manufacturing thereof may be simplified.

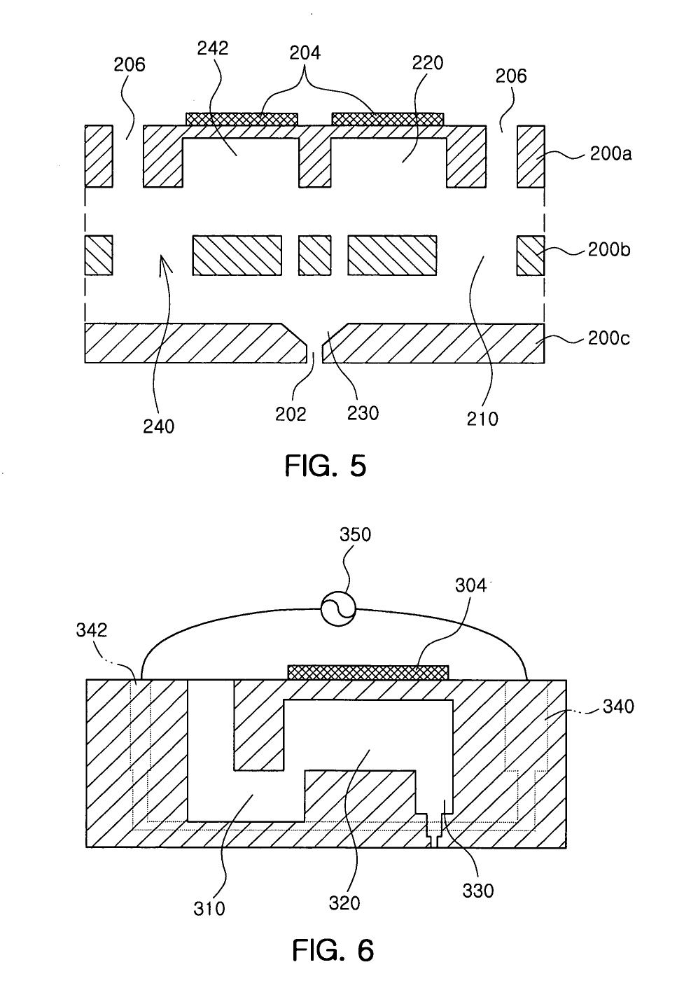

FIG. 4 is a cross-sectional view illustrating an inkjet print head according to another exemplary embodiment of the present invention. FIG. 5 is an exploded cross-sectional view illustrating the inkjet print head of FIG. 4.

With reference to FIGS. 4 and 5, an inkjet print head may include a first reservoir 210, a first pressure chamber 220 and a damper 230.

The configuration of the first reservoir 210 and the first pressure chamber 220 in this embodiment is substantially the same as that in the aforementioned embodiment, so a detailed description thereof will be omitted.

The damper 230 is connected to an ink flow path 240. As a result, the single damper 230 is connected to two ink flow paths.

The damper 230 may have a diameter greater than that of a nozzle 202. The diameter of the damper 230 is gradually narrowed towards the nozzle 202.

This structure allows for the control of the amount of inks ejected from the first pressure chamber 220 and a second pressure chamber 242 and the amount of inks ejected through the nozzle 202.

The inkjet print head may be manufactured by stacking a chamber plate 200a, an intermediate plate 200b, and a nozzle plate 200c to be bonded together.

The chamber plate 200a includes a plurality of first and second pressure chambers 220 and 242 disposed symmetrically, and first and second ink inlets 206 and 207 prepared for drawing inks therethrough.

The intermediate plate 200b may include the first reservoir 210 and a second reservoir 246 having a large length extending in a longitudinal direction, and portions connecting the damper 230 and the first and second pressure chambers 220 and 242.

The nozzle plate 200c may be bonded to the bottom of the intermediate plate 200b. The nozzle plate 200c may have a plurality of nozzles 202 arranged in a row. However, the positions of the nozzles 102 are not limited thereto.

Also, the nozzle plate 200c may have the damper 230 formed therein. However, the position of the damper 130 is not limited thereto. The damper 130 may be formed in the intermediate plate 200b.

In the inkjet print head according to this embodiment, first and second inks are ejected in a short time immediately after being mixed in the damper 230. Accordingly, the inkjet print head allows for the ejection of compound ink, i.e., ink which is formed of a combination of inks having different materials.

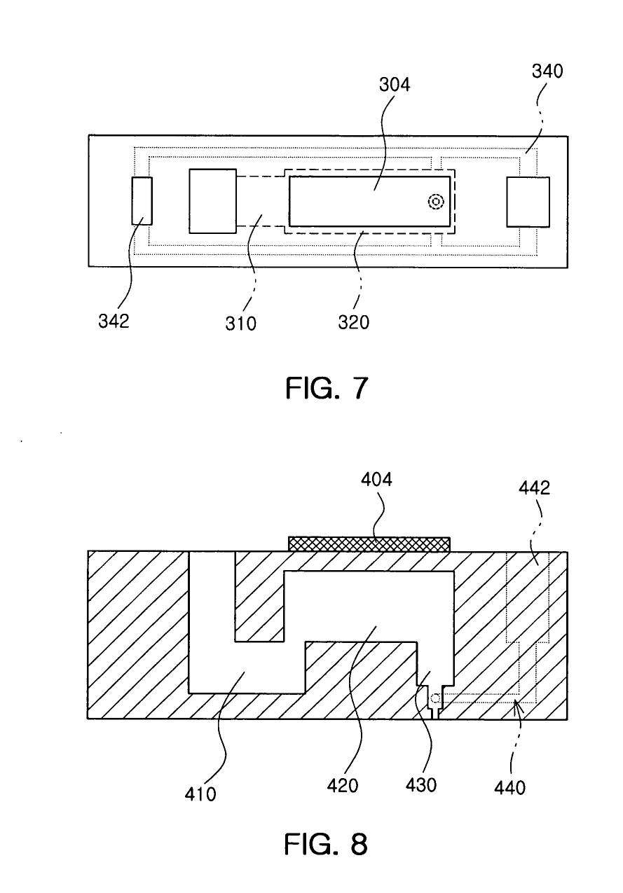

FIG. 6 is a cross-sectional view illustrating an inkjet print head according to another exemplary embodiment of the present invention. FIG. 7 is a plan view illustrating the inkjet print head of FIG. 6.

With reference to FIGS. 6 and 7, an inkjet print head may include a reservoir 310, a pressure chamber 320, a damper 330 and an ink flow path 340 through which a second ink flows.

The configuration of the reservoir 310, the pressure chamber 320 and the damper 330 in this embodiment is substantially the same as that in the aforementioned embodiment, so a detailed description thereof will be omitted.

The ink flow path 340 may have an opening 342 in the same surface as the surface an actuator 304 is mounted upon. Since a circulation system 350 operates with relation to the opening 342, the second ink is circulated through the ink flow path 340. Accordingly, the second ink is mixed with a first ink supplied by the pressure chamber 320.

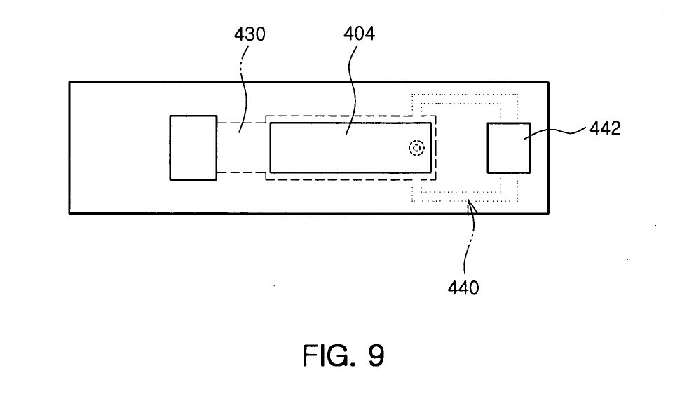

FIG. 8 is a cross-sectional view illustrating an inkjet print head according to another exemplary embodiment of the present invention. FIG. 9 is a plan view illustrating the inkjet print head of FIG. 8.

With reference to FIGS. 8 and 9, an inkjet print head may include a reservoir 410, a pressure chamber 420, a damper 430 and an ink flow path 440 through which a second ink flows.

The configuration of the reservoir 410, the pressure chamber 420 and the damper 430 in this embodiment is substantially the same as that in the aforementioned embodiment, so a detailed description thereof will be omitted.

The ink flow path 440 is connected to the damper 430. The ink flow path 440 may include two or more paths extending from an opening 442, adjacent to an actuator 404, to the sides of the damper 430.

Here, the second ink flows through the ink flow path 440 due to pneumatic pressure. However, the invention is not limited thereto.

In the inkjet print head according to this embodiment, the second ink is drawn into the damper 430 through the ink flow path 440 and is subsequently mixed with a first ink supplied by the pressure chamber 420, and the mixed first and second inks are ejected through a nozzle immediately after being mixed in the damper 430. The mixed inks are ejected in a short period of time, and accordingly, the inkjet print head allows for the ejection of compound ink, i.e., ink which is formed of a combination of inks having different materials.

As set forth above, in an inkjet print head according to exemplary embodiments of the invention, different types of inks are mixed in a damper and are subsequently ejected through a nozzle in a short period of time. Accordingly, the inkjet print head allows for the ejection of compound ink, i.e., ink formed of a combination of inks having different materials.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet print head comprising:
a reservoir storing a first ink drawn in through an ink inlet;
a pressure chamber storing the first ink drawn in from the reservoir and transferring the first ink to a nozzle by a driving force of an actuator; and
a damper disposed between the pressure chamber and the nozzle and allowing the first ink to be mixed with a second ink drawn through an ink flow path for the second ink.

2. The inkjet print head of claim 1, wherein the ink flow path includes a further reservoir and a further pressure chamber symmetrically corresponding to the reservoir and the pressure chamber with the damper being disposed between the symmetrically opposed pressure chambers.

3. The inkjet print head of claim 1, wherein the ink flow path is a circulation path disposed outwardly of the reservoir and the pressure chamber.

4. The inkjet print head of claim 1, wherein the ink flow path is a path extending from a further ink inlet for the second ink to the damper.

5. The inkjet print head of claim 1, further comprising:
a chamber plate having the pressure chamber provided therein; and
a nozzle plate having the nozzle provided therein, the chamber plate being stacked on the nozzle plate.

6. The inkjet print head of claim 5, further comprising an intermediate plate interposed between the chamber plate and the nozzle plate and including the damper connecting the pressure chamber and the nozzle.

7. The inkjet print head of claim 1, further comprising a further actuator for transferring the second ink of the ink flow path to the damper.

8. The inkjet print head of claim 1, wherein the damper has a diameter gradually narrowed towards the nozzle.
